(19) United States
(12) Patent Application Publication
(10) Pub. No.: US 2019/0356800 A1
(43) Pub. Date: Nov. 21, 2019

(54) IMAGE PROCESSING APPARATUS

(71) Applicant: KYOCERA Document Solutions Inc., Osaka (JP)

(72) Inventor: Sadahiro Matsuura, Osaka (JP)

(21) Appl. No.: 16/412,793

(22) Filed: May 15, 2019

(30) Foreign Application Priority Data
May 16, 2018 (JP) 2018-094342

(51) Int. Cl. H04N 1/00; H01F 7/06; H01F 7/02

(52) U.S. Cl. CPC H04N 1/00888; H04N 1/00599; H01F 7/0252; H01F 7/064

(57) ABSTRACT

An image processing apparatus includes a solenoid, a power supply switch element, a control device, a current value integrator circuit, a state determination circuit, and a cut-off circuit. The current value integrator circuit outputs an integral signal that increases in level, in response to an integral value of an operation current, when the operation current is conducted to the solenoid, and otherwise decreases in level. The state determination circuit maintains a state determination signal in an active state when the level of the integral signal exceeds a maximum level. The cut-off circuit conducts the operation current when the state determination signal in a negative state is input to a power supply line that extends to a circuit between the power supply switch element and the solenoid, and cuts off the operation current when the state determination signal in the active state is input to the power supply line.

### INCORPORATION BY REFERENCE

This application is based upon and claims the benefit of priority from the corresponding Japanese Patent Application No. 2018-094342 filed on May 16, 2018, the entire contents of which are incorporated herein by reference.

### BACKGROUND

The present disclosure relates to an image processing apparatus including a solenoid.

An image processing apparatus that is a printer, a scanner, a copier, or a multifunction peripheral includes a movable member whose attitude is switched by an actuator. For example, the movable member is a movable guiding member for guiding a moving sheet such as a print sheet or a document sheet.

In the image processing apparatus, a solenoid may switch the attitude of the movable guiding member between two attitudes that guide the sheet in different directions. In this case, a switch element such as a transistor that is electrically connected to the solenoid switches, in response to a control signal input thereto, between a state where it supplies an operation current to the solenoid and a state where it cuts off the operation current.

When the switch element is short-circuited due to damage, there is a risk that the solenoid could be damaged due to the operation current flowing to the solenoid for a long period of time.

When the solenoid is short-circuited due to damage, an overcurrent flows through the solenoid and the switch element. Accordingly, a solenoid including a protective thermal fuse may be adopted.

When the solenoid itself is damaged, or when the thermal fuse of the solenoid melts, it is necessary to replace the solenoid. Since the solenoid is fixed in a small space in which various mechanisms are disposed, replacement of the solenoid is a complicated task.

On the other hand, when the control signal is a modulated signal such as a PWM (Pulse Width Modulation) signal, residual voltage of the switch element varies greatly between when the switch element is functioning normally and when the switch element is short-circuited.

It is known that a release means connecting a power supply and the solenoid is released when the residual voltage of the switch element is low. With this configuration, it is possible to prevent the operation current from flowing to the solenoid for a long period of time when the switch element is damaged, and to prevent the solenoid from being damaged.

### SUMMARY

An image processing apparatus according to an aspect of the present disclosure includes a movable member relating to an imaging process, a solenoid, a power supply switch element, a control device, a current value integrator circuit, a state determination circuit, and a cut-off circuit. The solenoid changes an attitude of the movable member by being supplied with an operation current from a power supply. The power supply switch element that is a semiconductor element electrically connected in series with the solenoid, conducts the operation current upon receiving a control signal in an active state, and cuts off the operation current upon receiving the control signal in a negative state. The control device, when switching the attitude of the movable member, continuously outputs the control signal in the active state to the power supply switch element for a predetermined reference time period, and then returns the control signal to the negative state. The current value integrator circuit outputs an integral signal that increases in level in response to an integral value of the operation current when the operation current is conducted to the solenoid, and decreases in level when the operation current is cut-off from the solenoid. The state determination circuit outputs a state determination signal in a negative state when the level of the integral signal does not exceed a predetermined maximum level, and maintains the state determination signal in an active state when the level of the integral signal exceeds the maximum level. The cut-off circuit conducts the operation current when the determination signal in the negative state is input to a power supply line that extends between the power supply and a circuit between the power supply switch element and the solenoid, and cuts off the operation current when the determination signal in the active state is input to the power supply line. The maximum level is higher than the level of the integral signal of when the operation current is continuously conducted, for the reference time period, to the power supply switch element and the solenoid that are functioning normally.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image processing apparatus according to an embodiment.

FIG. 2 is a configuration diagram of a sheet guiding mechanism in the image processing apparatus according to the embodiment.

FIG. 3 is a configuration diagram of a recording material peeling mechanism in the image processing apparatus according to the embodiment.

FIG. 4 is a configuration diagram of a solenoid control portion in the image processing apparatus according to the embodiment.

FIG. 5 is a timing diagram for signals when a solenoid and the solenoid control portion are functioning normally.

FIG. 6 is a timing diagram for signals when a power supply switch element of the solenoid control portion is functioning abnormally.

FIG. 7 is a timing diagram for signals when the solenoid is functioning abnormally.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

[Configuration of Image Processing Apparatus 10]

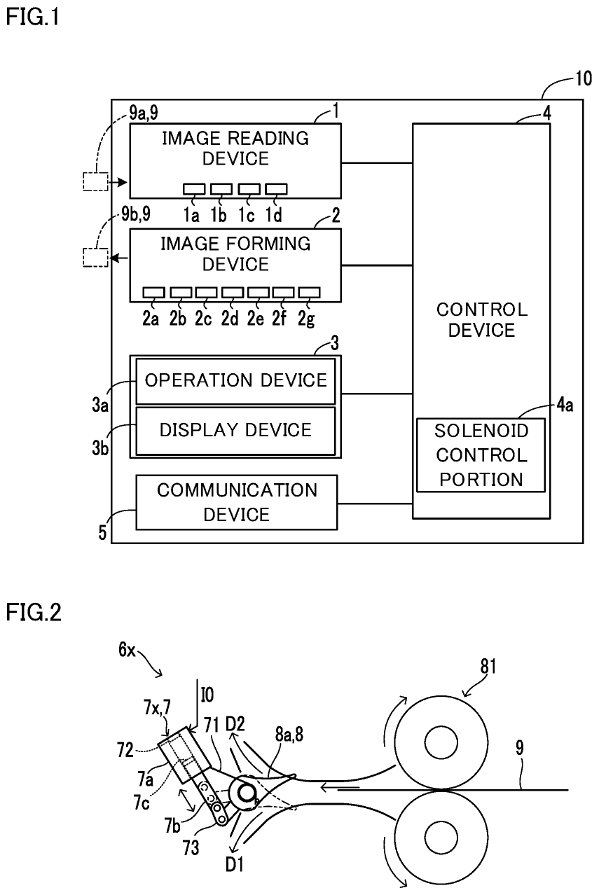

An image processing apparatus 10 according to the present embodiment executes image processes such as various types of data processes of image data, an image reading process for reading an image from a document sheet 91, and a print process for forming an image on a paper sheet 92 (see FIG. 1).

It is noted that in the print process, the image may be formed on a resin sheet or the like. The paper sheet 92 and the resin sheet are examples of sheet-like recording material for an image.

As shown in FIG. 1, the image processing apparatus 10 includes an image reading device 1, an image forming device 2, a user interface unit 3, a control device 4, and a communication device 5.

The user interface unit 3 includes an operation device 3a and a display device 3b. The operation device 3a receives an operation from a user, and includes, for example, a touch panel. The display device 3b displays an image, and includes, for example, a display panel such as a liquid crystal display panel.

The communication device 5 communicates with another device, such as an image processing device, via a network. The control device 4 performs all transmission and reception of data to and from the other device via the communication device 5.

The image reading device 1 executes the image reading process. The image reading device 1 includes a light source 1a, an ADF (Automatic Document Feeder) 1b, an image sensor 1c, and an AFE (Analog Front End) 1d.

The light source 1a irradiates light on the document sheet 91. The ADF 1b conveys the document sheet 91 along a document sheet conveyance path. By conveying the document sheet 91 using the ADF 1b, the light from the light source 1a is scanned along the document sheet 91. The image sensor 1c receives light reflected from the document sheet 91, and outputs, as an image signal, a detection signal of an amount of the received light.

The AFE 1d converts the image signal to digital image data. Hereinafter, an image read from the document sheet 91 by the image reading process of the image reading device 1 is referred to as a read image.

The image forming device 2 executes the print process by a predetermined method, such as an electrophotographic method or an inkjet method.

For example, when the image forming device 2 executes the print process by the electrophotographic method, the image forming device 2 includes a sheet conveying mechanism 2a, a photoconductor 2b, a charging device 2c, a laser scanning unit 2d, a developing device 2e, a transfer body 2f, and a fixing device 2g.

The sheet conveying mechanism 2a conveys the paper sheet 92 along a predetermined path. As the photoconductor 2b rotates, the charging device 2c charges a surface thereof. The laser scanning unit 2d writes an electrostatic latent image on the charged surface of the photoconductor 2b.

The developing device 2e develops the electrostatic latent image on the rotating photoconductor 2b into a toner image. The photoconductor 2b is an example of an image-carrying member for carrying the toner image while rotating.

The transfer body 2f, as it is applied with a transfer voltage, rotates while forming a nip portion between itself and the photoconductor 2b. With this configuration, the transfer body 2f transfers the toner image from the surface of the photoconductor 2b to the paper sheet 92.

The fixing device 2g fixes the toner image to the paper sheet 92 by heating the toner image on the paper sheet 92.

The image forming device 2 and the communication device 5 execute a print job. In the print job, the communication device 5 receives print data from the other device, and the image forming device 2 executes the print process based on the print data.

The image reading device 1 and the communication device 5 execute an image transmission job. In the data transmission job, the image reading device 1 executes the image reading process, and the communication device 5 transmits, via the network to the other device such as the information processing device, data of the read image that is obtained in the image reading process.

In addition, the image reading device 1 and the image forming device 2 execute a copy job. In the copy job, the image reading device 1 executes the image reading process, and the image forming device 2 executes the print process based on data of the read image that is obtained in the image reading process.

The control device 4 executes various types of arithmetic processes and data processes, and controls various electronic devices that are included in the image processing apparatus 10. The control device 4 exchanges data and control signals with the image reading device 1, the image forming device 2, the user interface unit 3, and the communication device 5.

Hereinafter, the document sheet 91 conveyed by the ADF 1b in the image reading process and the paper sheet 92 conveyed by the sheet conveying mechanism 2a in the print process are referred to as a sheet 9.

The ADF 1b and the sheet conveying mechanism 2a includes a sheet guiding mechanism 6x, as shown in FIG. 2. The sheet guiding mechanism 6x includes a movable guiding member 8a, and a first solenoid 7x that is an actuator for switching an attitude of the movable guiding member 8a.

The movable guiding member 8a guides the sheet 9 that is conveyed by a conveyance roller pair 81 in the print process. The movable guiding member 8a is swingably supported in a branch portion of a conveyance path of the sheet 9. The movable guiding member 8a is switched by the first solenoid 7x between two attitudes in which the sheet 9 is guided in different guiding directions.

In FIG. 2, the movable guiding member 8a in a first attitude is shown with a solid line, and the movable guiding member 8a in a second attitude is shown with an imaginary line (two-dot chain line). When held in the first attitude, the movable guiding member 8a guides the sheet 9 in a first conveyance direction D1, and when held in the second attitude, the movable guiding member 8a guides the sheet 9 in a second conveyance direction D2.

The first solenoid 7x includes a fixed body portion 7a, and a reciprocally displaceable displacement portion 7b. The displacement portion 7b of the first solenoid 7x is connected to the movable guiding member 8a by a link mechanism 73.

In the example shown in FIG. 2, the first solenoid 7x switches the attitude of the movable guiding member 8a from the second attitude to the first attitude, by pushing out the displacement portion 7b from the body portion 7a. The first solenoid 7x switches the attitude of the movable guiding member 8a from the first attitude to the second attitude by pulling in the displacement portion 7b toward the body portion 7a.

The sheet guiding mechanism 6x further includes a first holding mechanism 71 and a second holding mechanism 72. The first holding mechanism 71 applies a force to the movable guiding member 8a that holds the movable guiding member 8a in the first attitude. On the other hand, the second holding mechanism 72 applies a force to the movable guiding member 8a that holds the movable guiding member 8a in the second attitude.

For example, the first holding mechanism 71 is a spring that applies elastic force to the movable guiding member 8a in a direction extending towards the first attitude. In the example shown in FIG. 2, the first holding mechanism 71 is a helical spring. The helical spring can be disposed in a small space. The first holding mechanism 71 may also be a coil spring.

The first holding mechanism 71 is a mechanism for holding, at a pushed-out position from the body portion 7a, the displacement portion 7b that is connected to the movable guiding member 8a.

In addition, the second holding mechanism 72 includes a permanent magnet for holding, by magnetic force, the displacement portion 7b at a pulled-in position toward the body portion 7a. That is, the permanent magnet that configures the second holding mechanism 72 applies, to the movable guiding member 8a, a magnetic force that holds the movable guiding member 8a in the second attitude.

In the example shown in FIG. 2, a portion of the body portion 7a that comes in contact with an inner end portion 7c of the displacement portion 7b is the permanent magnet that configures the second holding mechanism 72. In this case, the inner end portion 7c of the displacement portion 7b is a ferromagnetic material such as iron. The inner end portion 7c is an end portion of the displacement portion 7b on the body portion 7a side.

The force by which the permanent magnet configuring the second holding mechanism 72 holds the movable guiding member 8a in the second attitude is larger than the force that is applied to the movable guiding member 8a in the second attitude from the spring configuring the first holding mechanism 71.

It is noted that in the state where the displacement portion 7b is pulled in the body portion 7a, that is, in the state where the movable guiding member 8a is in the second attitude, among the inner end portion 7c of the displacement portion 7b and a portion of the body portion 7a that comes in contact with the inner end portion 7c, one is the permanent magnet, and the other is the ferromagnetic material.

The first solenoid 7x switches the attitude of the movable guiding member 8a between the first attitude and the second attitude against the holding force of the first holding mechanism 71 or the second holding mechanism 72.

When the attitude of the movable guiding member 8a is switched by the first solenoid 7x to the first attitude or the second attitude, even when an operation current I0 is stopped being supplied to the first solenoid 7x, the first holding mechanism 71 and the second holding mechanism 72 maintain holding the movable guiding member 8a in the first attitude or the second attitude.

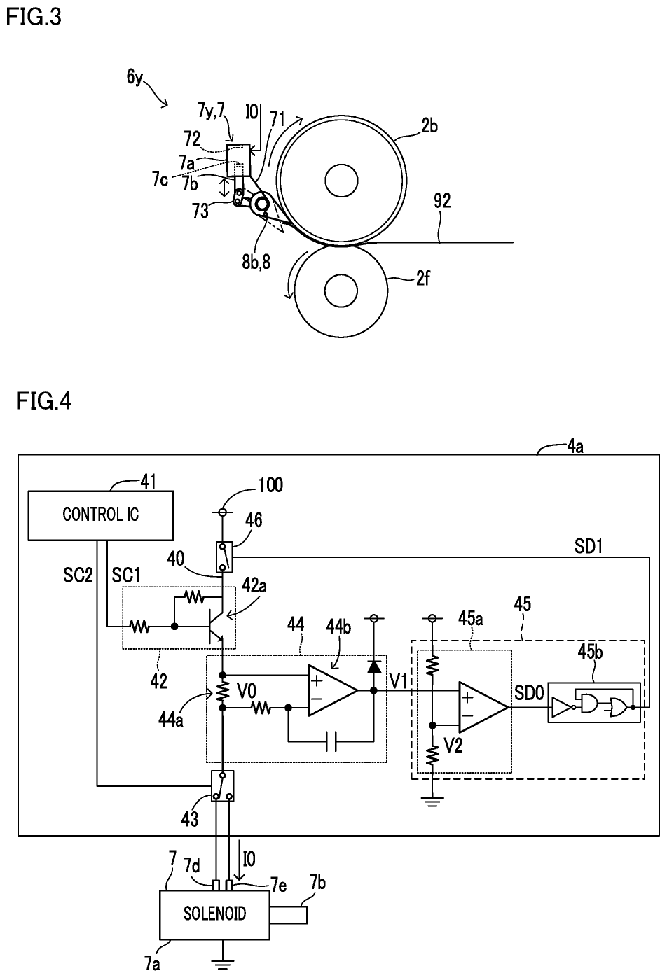

The image forming device 2 includes, for example, a recording material peeling mechanism 6y as shown in FIG. 3. The recording material peeling mechanism 6y includes a movable claw member 8b and a second solenoid 7y that is an actuator for switching an attitude of the movable claw member 8b.

The movable claw member 8b, in a state where its tip is in contact with the surface of the rotating photoconductor 2b, peels off the paper sheet 92 that is attached to the surface of the photoconductor 2b after the toner image has been transferred from the photoconductor 2b to the paper sheet 92.

The movable claw member 8b is swingably supported at a position that is more downstream, in a rotational direction of the photoconductor 2b, than the nip portion between the photoconductor 2b and the transfer body 2f. The attitude of the movable claw member 8b is switched by the second solenoid 7y between a first attitude in which it is in contact with the photoconductor 2b, and a second attitude in which it is separated from the photoconductor 2b.

FIG. 3 shows the movable claw member 8b in the first attitude with a solid line, and the movable claw member 8b in the second attitude with an imaginary line (two-dot chain line).

Similarly to the first solenoid 7x, the second solenoid 7y includes the fixed body portion 7a and the reciprocally displaceable displacement portion 7b. The displacement portion 7b of the second solenoid 7y is connected to the movable claw member 8b by the link mechanism 73.

In the example shown in FIG. 3, the second solenoid 7y switches the attitude of the movable claw member 8b from the second attitude to the first attitude, by pushing out the displacement portion 7b from the body portion 7a. The second solenoid 7y switches the attitude of the movable claw member 8b from the first attitude to the second attitude by pulling in the displacement portion 7b toward the body portion 7a.

Similarly to the sheet guiding mechanism 6x, the recording material peeling mechanism 6y includes the first holding mechanism 71 and the second holding mechanism 72. The first holding mechanism 71 of the recording material peeling mechanism 6y applies a force to the movable claw member 8b that holds the movable claw member 8b in the first attitude. On the other hand, the second holding mechanism 72 applies a force to the movable claw member 8b that holds the movable claw member 8b in the second attitude.

Configurations of the first holding mechanism 71 and second holding mechanism 72 of the recording material peeling mechanism 6y are the same as those of the sheet guiding mechanism 6x. Accordingly, descriptions of the configurations of the first holding mechanism 71 and second holding mechanism 72 of the recording material peeling mechanism 6y are omitted.

Hereinafter, the first solenoid 7x and the second solenoid 7y are collectively referred to as a solenoid 7. The movable guiding member 8a and the movable claw member 8b whose attitudes are switched by the solenoid 7 are examples of a movable member 8 that is related to the image processes.

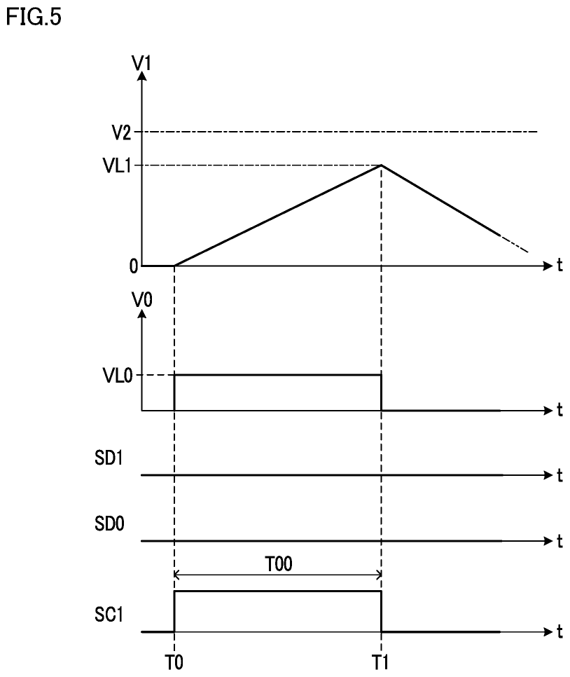

As shown in FIG. 1, the control device 4 includes a solenoid control portion 4a. As shown in FIG. 4, the solenoid control portion 4a includes a power supply switch element 42a that is electrically connected in series to the solenoid 7. The power supply switch element 42a is a semiconductor element such as a transistor.

The solenoid 7 switches the attitude of the movable member 8 by being supplied with the operation current I0 from the DC power supply 100 via the power supply switch element 42a.

The power supply switch element 42a conducts the operation current I0 when an active first control signal SC1 is input thereto, and cuts off the operation current I0 when a negative first control signal SC1 is input thereto.

That is, the power supply switch element 42a, in response to the first control signal SC1 input thereto, switches between a conducting state where it supplies the operation current I0 to the solenoid 7, and a cut-off state where it cuts off the operation current I0 from the solenoid 7. In the present embodiment, the first control signal SC1 is an unmodulated DC voltage signal.

Furthermore, the solenoid control portion 4a includes an output relay 43. The output relay 43, in response to a second control signal SC2 input thereto, switches between supplying the operation current I0 to a first power supply terminal 7d, and supplying the operation current I0 to a second power supply terminal 7e.

When the operation current I0 is supplied to the first power supply terminal 7d, the solenoid 7 performs an operation of pushing out the displacement portion 7b from the body portion 7a. In addition, when the operation current I0 is supplied to the second power supply terminal 7e, the solenoid 7 performs an operation of pulling in the displacement portion 7b toward the body portion 7a.

The solenoid control portion 4a of the control device 4 further includes a control IC (Integrated Circuit) 41. The control IC 41 controls the solenoid 7 by outputting the first control signal SC1 and the second control signal SC2.

That is, by controlling the solenoid 7, the control IC 41 controls the attitude of the movable member 8 that is connected to the solenoid 7.

In order to downsize the image processing apparatus 10, a relatively small-sized solenoid 7 is adopted. For this reason, when the operation current I0 is supplied for a long period of time to allow the solenoid 7 to exert a required driving force, there is a risk of damaging the solenoid 7.

For example, when the power supply switch element 42a is short-circuited due to damage, the solenoid 7 can become damaged due to the operation current I0 flowing to the solenoid 7 for a long period of time.

When the solenoid 7 is short-circuited due to damage, an overcurrent flows through the solenoid 7 and the power supply switch element 42a. Accordingly, a solenoid including a protective thermal fuse is adopted for the first solenoid 7x and the second solenoid 7y.

When the solenoid 7 itself is damaged, or when the thermal fuse of the solenoid 7 melts, it is necessary to replace the solenoid 7. Since the solenoid 7 is fixed in a small space in which various mechanisms are disposed, replacement of the solenoid 7 is a complicated task.

Meanwhile, the operation current I0 can flow to the solenoid 7 for a long period of time as a result of a cause other than damage to the power supply switch element 42a. For example, an abnormality of the control IC 41 that outputs the first control signal SC1 may be the cause of the active first control signal SC1 being output for a long period of time.

In addition, when the first control signal SC1 is a DC signal that is not a modulated signal, residual voltage of the power supply switch element 42a is almost the same between when the power supply switch element 42a is functioning normally and when it is short-circuited.

For this reason, when the first control signal SC1 is a DC signal, it is difficult to determine malfunctioning of the power supply switch element 42a based on its residual voltage.

The image processing apparatus 10 includes the solenoid control portion 4a shown in FIG. 4. Accordingly, the image processing apparatus 10 can prevent the solenoid 7 from being damaged due to the operation current I0 flowing to the solenoid 7 for a long period of time.

As described above, the solenoid control portion 4a includes the control IC 41, the power supply switch element 42a, and the output relay 43 that are electrically connected to one another in series. The power supply switch element 42a configures the drum cleaning device 42 together with resistive elements (see FIG. 4).

As shown in FIG. 5, the control IC 41 switches the attitude of the movable member 8 by continuously outputting the active first control signal SC1 to the power supply switch element 42a during a predetermined reference time period TOO, and then returning the first control signal SC1 to the negative state.

FIG. 5 shows an example where the control IC 41 continuously outputs the active DC first control signal SC1 from a start time T0 to an end time T1. In this case, during a time period excluding the time period from the start time T0 to the end time T1, the operation current I0 is not supplied to the solenoid 7.

When the first control signal SC1 is in the negative state, the first holding mechanism 71 and the second holding mechanism 72 each holds the movable member 8 in a constant attitude, without requiring the solenoid 7 to consume power.

Furthermore, as shown in FIG. 4, the solenoid control portion 4a includes a current value integrator circuit 44, a state determination circuit 45, and a cut-off circuit 46.

The current value integrator circuit 44 outputs an integral signal V1 that increases in level in response to an integral value of the operation current I0 when the operation current I0 is conducted to the solenoid 7, and decreases in level when the operation current I0 is cut-off from the solenoid 7.

The current value integrator circuit 44 includes a detection resistive element 44a and a known integrator circuit 44b. The detection resistive element 44a is electrically connected in series to the power supply switch element 42a and the solenoid 7. The detection resistive element 44a outputs, to the integrator circuit 44b, a current detection voltage V0 that indicates a magnitude of the operation current I0 flowing from the power supply switch element 42a to the solenoid 7.

As shown in FIG. 5, when the operation current I0 is conducted to the solenoid 7, the integrator circuit 44b outputs the integral signal V1 that increases in level at a slope that is proportional to the current detection voltage V0. The voltage level of the integral signal V1 indicates the integral value of the operation current I0 flowing through the solenoid 7.

On the other hand, when supply of the operation current I0 to the solenoid 7 is cut off, that is, when the level of the current detection voltage V0 is zero, the integrator circuit 44b outputs the integral signal V1 that linearly decreases in level (see FIG. 5).

The state determination circuit 45 outputs a negative state determination signal SD1 while the level of the integral signal V1 does not exceed a level of a predetermined reference voltage V2. Furthermore, the state determination circuit 45 maintains the state determination signal SD1 in an active state after the level of the integral signal V1 exceeds that of the reference voltage V2.

As shown in FIG. 5, the level of the reference voltage V2 is higher than that of a standard integral level VL1, that is a level of the integral signal V1 when the operation current I0 is continuously conducted for the reference time period TOO to the power supply switch element 42a and the solenoid 7 that are functioning normally.

It is noted that the level of the reference voltage V2 is the same as a maximum level of the integral signal V1 when an abnormality occurs in power supply to the solenoid 7.

As shown in FIG. 4, the state determination circuit 45 includes a known comparator circuit 45a and a known latch circuit 45b. The integral signal V1 is input to the comparator circuit 45a, and a comparison signal xSD0 that is output from the comparator circuit 45a is input to the latch circuit 45b.

The comparator circuit 45a compares amplitudes of the levels of the integral signal V1 and the reference voltage V2, and outputs a comparison signal SD0 as a comparison result signal. When the level of the integral signal V1 is higher than the level of the reference voltage V2, the comparator circuit 45a outputs an active comparison signal SD0, and otherwise outputs a negative comparison signal SD0.

The latch circuit 45b outputs the negative determination signal SD1 until the comparison signal SD0 becomes active. Furthermore, once the comparison signal SD0 becomes active, the latch circuit 45b continuously outputs the active determination signal SD1 until the latch circuit 45b is reset when power supply thereto is stopped.

That is, the latch circuit 45b generates the state determination signal SD1 by receiving the comparison signal SD0 and latching the active comparison signal SD0.

The cut-off circuit 46 is provided in a power supply line 40 that extends between the DC power supply 100 and the circuit from the power supply switch element 42a to the solenoid 7. For example, a relay circuit may be adopted for the cut-off circuit 46.

When the cut-off circuit 46 receives the negative state determination signal SD1, it conducts the operation current I0, and when the cut-off circuit 46 receives the active state determination signal SD1, it cuts off the operation current I0.

As shown in FIG. 5, when the power supply switch element 42a and the solenoid 7 are functioning normally, that is, when power supply to the solenoid 7 is normal, the current detection voltage V0 at a standard detection level VL0 is continuously supplied to the integrated circuit 44b for the reference time period TOO.

In the case described above, as long as the active first control signal SC1 is output for a sufficient period of time, the level of the integral signal V1 does not exceed that of the reference voltage V2. Accordingly, the comparison signal SD0 and the state determination signal SD1 are maintained in their negative states.

The control IC 41, after outputting the negative first control signal SC1 for a period of time that is longer than at least what is necessary for the level of the integral signal V1, output by the current value integrated circuit 44, to decrease from the standard integral level VL1 to zero, outputs the next active first control signal SC1.

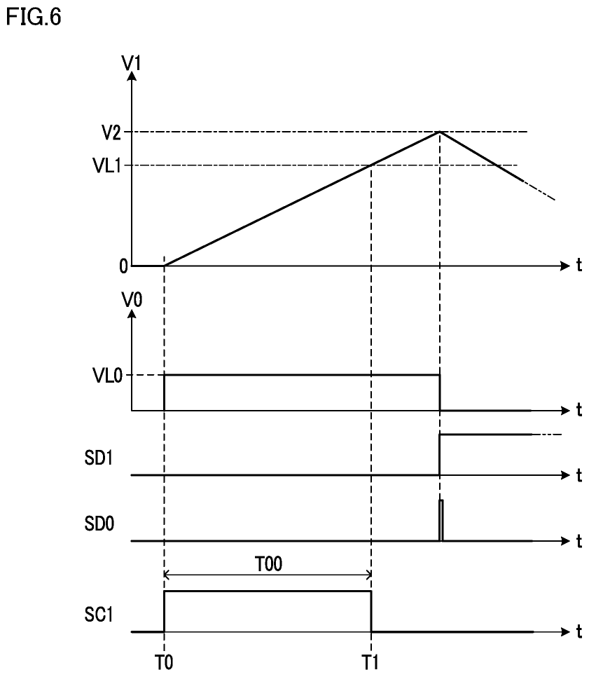

FIG. 6 shows changes in signals when the power supply switch element 42a is short-circuited due to damage.

When the power supply switch element 42a is short-circuited, even if the active first control signal SC1 is only continuously output for the reference time period TOO, the current detection voltage V0 at the standard detection level VL0 is continuously supplied to the integrated circuit 44b for a time period that exceeds the reference time period TOO.

Accordingly, the level of the integral signal V1 exceeds that of the reference voltage V2, the comparator circuit 45a momentarily outputs the active comparison signal SD0, and the latch circuit 45b outputs the active state determination signal SD1.

Furthermore, the cut-off circuit 46 receives the active state determination signal SD1, and cuts-off the operation current I0. With this configuration, it is possible to prevent the solenoid 7 from being damaged due to damage to the power supply switch element 42a.

It is noted that when the operation current I0 is cut-off, although the level of the integral signal V1 becomes lower than that of the reference voltage V2 and the comparison signal SD0 returns to the negative state, the latch circuit 45b maintains the state determination signal SD1 in the active state.

The solenoid control portion 4a including the power supply switch element 42a is disposed at a position in the image processing apparatus 10 where it can be replaced more easily compared to the solenoid 7.

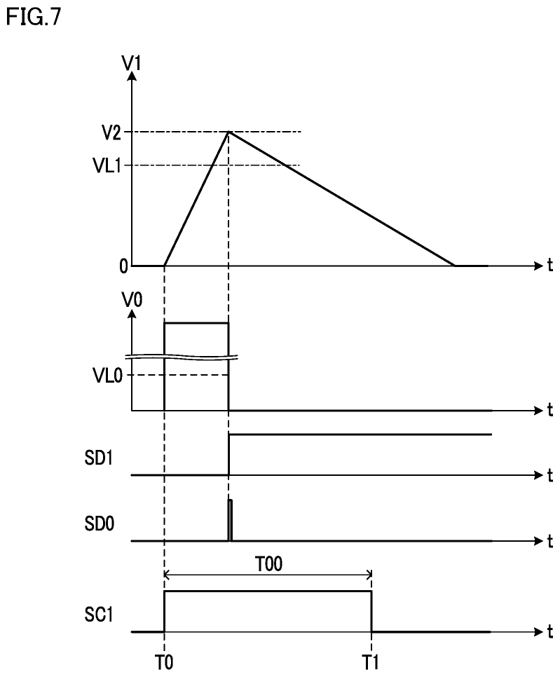

FIG. 7 shows changes in signals when the power supply switch element 42a is functioning normally and the solenoid 7 is short-circuited due to damage.

When the solenoid 7 is short-circuited, output of the active first control signal SC1 causes a current that is stronger than the standard operation current I0 to flow through the detection resistive element 44a. This causes the current detection voltage V0 to be continuously supplied to the integrated circuit 44b at a level that exceeds the standard detection level VL0.

Accordingly, the level of the integral signal V1 increases at a higher rate than normal, and prematurely exceeds the level of the reference voltage V2 before the reference time period TOO has elapsed. As a result, the comparator circuit 45a to momentarily outputs the active comparison signal SD0, and the latch circuit 45b outputs the active state determination signal SD1.

Furthermore, the cut-off circuit 46 receives the active state determination signal SD1, and cuts off the operation current I0. With this configuration, it is possible to prevent an excessive current from being continuously supplied to the damaged solenoid 7.

Accordingly, even when the solenoid 7 is not provided with the protective thermal fuse, it is possible to prevent a serious accident from occurring due to the excessive current being supplied to the solenoid 7.

### APPLICATION EXAMPLE

In the image processing apparatus 10, both the first holding mechanism 71 and the second holding mechanism 72 may be a mechanism including a permanent magnet that holds the movable member 8 by magnetic force. In addition, a mechanism including a permanent magnet may be adopted as the first holding mechanism 71, and a mechanism including a spring may be adopted as the second holding mechanism 72.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus, comprising:
a movable member relating to an imaging process;
a solenoid configured to change an attitude of the movable member by receiving an operation current from a power supply;
a power supply switch element that is a semiconductor element electrically connected in series with the solenoid, and is configured to conduct the operation current upon receiving a control signal in an active state, and cut off the operation current upon receiving the control signal in a negative state;
a control device configured to, when switching the attitude of the movable member, continuously output the control signal in the active state to the power supply switch element for a predetermined reference time period and then return the control signal to the negative state;
a current value integrator circuit configured to output an integral signal that increases in level in response to an integral value of the operation current when the operation current is conducted to the solenoid, and decreases in level when the operation current is cut off from the solenoid;
a state determination circuit configured to output a state determination signal in a negative state when the level of the integral signal does not exceed a predetermined maximum level, and to maintain the state determination signal in an active state when the level of the integral signal exceeds the maximum level; and
a cut-off circuit configured to conduct the operation current when the determination signal in the negative state is input to a power supply line that extends between the power supply and a circuit between the power supply switch element and the solenoid, and to cut off the operation current when the determination signal in the active state is input to the power supply line, wherein
the maximum level is higher than the level of the integral signal of when the operation current is continuously conducted, for the reference time period, to the power supply switch element and the solenoid that are functioning normally.

2. The image processing apparatus according to claim 1, wherein
the movable member guides a sheet that is recording material conveyed in a print process for forming an image on the recording material, or is a document sheet conveyed in an image reading process for reading an image from the document sheet, and the attitude of the movable member is switched by the solenoid between two attitudes in which the sheet is guided in different directions.

3. The image processing apparatus according to claim 2, further comprising
a first holding mechanism configured to apply a force to the movable member that holds the movable member in a first attitude, and
a second holding mechanism configured to apply a force to the movable member that holds the movable member in a second attitude, wherein
the solenoid switches the attitude of the movable member between the first attitude and the second attitude against the holding force of the first holding mechanism or the second holding mechanism.

4. The image processing apparatus according to claim 1, wherein
in a state where a tip of the movable member is in contact with a rotating image-carrying member, after a toner image has been transferred from the image-carrying member to recording material, the movable member peels off the recording material that is attached to the surface of the image-carrying member, and
the attitude of the movable member is switched by the solenoid between an attitude in which the movable member is in contact with the image-carrying member and an attitude in which the movable member is separated from the image-carrying member.

5. The image processing apparatus according to claim 4, further comprising
a first holding mechanism configured to apply a force to the movable member that holds the movable member in a first attitude, and
a second holding mechanism configured to apply a force to the movable member that holds the movable member in a second attitude, wherein
the solenoid switches the attitude of the movable member between the first attitude and the second attitude against the holding force of the first holding mechanism or the second holding mechanism.

6. The image processing apparatus according to claim 5, wherein
either or both of the first holding mechanism and the second holding mechanism includes a permanent magnet that applies a magnetic force to the movable member.

7. The image processing apparatus according to claim 1, wherein
the state determination circuit includes
a comparator circuit configured to compare amplitudes of levels of the integral signal and a reference signal that indicates the maximum level, and output a comparison result signal, and
a latch circuit configured to generate the state determination signal by receiving the comparison result signal and latching the comparison result signal in an active state.
